(19) United States
(12) Patent Application Publication
(10) Pub. No.: US 2010/0258960 A1
(43) Pub. Date: Oct. 14, 2010

(54) PROCESS FOR PRODUCING OPTICAL FILM MADE OF THERMOPLASTIC RESIN

(75) Inventors: Hiroaki Takahata, Ichihara-shi (JP); Yoshinori Takahashi, Ichihara-shi (JP); Kyoko Hino, Nerima-ku (JP); Yoshiaki Ishigami, Ota-ku (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Chuo-ku, Tokyo (JP)

(21) Appl. No.: 12/679,282

(22) PCT Filed: Sep. 17, 2008
(86) PCT No.: PCT/JP2008/066773

§ 371 Date: Jun. 8, 2010

(30) Foreign Application Priority Data
Sep. 21, 2007 (JP) 2007-245652

(51) Int. Cl. B29D 11/00

(52) U.S. Cl. 264/1.6

(57) ABSTRACT

There is provided a process for producing an optical thermoplastic resin film that can yield films with almost no orientation and with high transparency.

The process for producing an optical thermoplastic resin film comprises a molding step of discharging a molten thermoplastic resin from a T-shaped die, and thereby molding it into a film form, and a cooling step of cooling and solidifying the molten resin molded in a film form by pressing it with a metal cooling roll 16 and a touch roll 14 in which a rubber roll 14b are disposed inside a tubular metal belt 14a, whereby the molten resin is cooled and solidified. In the cooling step, the surface temperature Ti of the cooling roll 16 is set so as to satisfy the condition represented by the following formula (1), while the surface temperature T2 of the belt 14a is set so as to satisfy the condition represented by the following formula (2).

Tg−30° C.≦T1+50° C. (1)

T1+10° C.≦T2≦T1+150° C. (2)

### TECHNICAL FIELD

The present invention relates to a process for producing an optical film made of a thermoplastic resin.

### BACKGROUND ART

Optical films such as retardation films and polarizer protective films that are used as structural members in liquid crystal displays (liquid crystal panels) are required to exhibit high optical homogeneity for the improvement in contrast and view angles.

A retardation film is produced by stretching a non-oriented precursor film for a retardation film so that the molecules may be oriented in the same direction and to the same degree. Controlling the orientation axis and the degree of orientation results in the formation of a retardation film which has uniformity of a desired phase difference. Therefore, non-stretched precursor films for retardation films and polarizer protective films that are normally not stretched are required to be free such defects as fisheyes, hard spots, or streaks called “die lines” in the films themselves, have high transparency, have minimal thickness deviation and be non-oriented.

Processes for producing cyclic olefin-based resin films are known in the art, wherein the discharge slit (lip) of a T-shaped die is plated with a special material capable of achieving a peel strength of not greater than 75N for molten cyclic olefin resins (molten resins) and the molten resin discharged from the T-shaped die into a film shape is pressed between a casting roll set to have a temperature of (the glass transition temperature of the cyclic olefin resin Tg −30° C.) or higher and not higher than (the glass transition temperature of the cyclic olefin resin Tg +30° C.) and a touch roll set to have a temperature of (the temperature of the casting roll −50° C.) or higher and not higher than the temperature of the casting roll, whereby the molten resin is cooled and solidified (see Patent Document 1, for example).

### [Patent Document 1] Japanese Unexamined Patent Application Publication No. 2000-280315

### DISCLOSURE OF THE INVENTION

### Problems to be Solved by the Invention

In the process described in cited document 1, however, the surface temperature of the casting roll which is in contact with the molten resin for a long time is higher than the surface temperature of the touch roll which is in contact with the molten resin for a very short time. Therefore, there has been a problem that the transparency of a produced film is impaired especially when a polypropylene-based resin is used.

Hence, it is an object of the present invention to provide a process for producing an optical thermoplastic resin film from which films with almost no orientation and high transparency can be obtained.

### Means for Solving the Problems

The process for producing an optical thermoplastic resin film according to the present invention comprises a melting step of melting and kneading a thermoplastic resin to form a molten resin, a molding step of discharging the molten resin from a T-shaped die at a temperature of 180° C. or higher and 300° C. or lower, and thereby molding it into a film form, and a cooling step of cooling and solidifying the molten resin molded in a film form by pressing it with a metal cooling roll and a presser in which one or more rubber rolls are disposed inside a tubular metal belt, wherein in the cooling step, the surface temperature of the cooling roll T1 [° C.] is set so as to satisfy the condition represented by the following formula (1), and the surface temperature of the belt of the presser T2 [° C.] is set so as to satisfy the condition represented by the following formula (2)

Tg−30° C.≦T1≦Tg+50° C. (1)

(Tg[° C.] is the intermediate point glass transition temperature of the thermoplastic resin.)

T1+10° C.≦T2≦T1+150° C. (2).

In the process for producing an optical thermoplastic resin film according to the present invention, the molten resin molded in a film form is pressed with a metal cooling roll and a presser in which one or more rubber rolls are disposed inside a tubular metal belt. Thus, since both surfaces of the molten resin molded in a film form is cooled by the cooling roll (casting roll) and the presser (touch roll), it is possible to cool and solidify the molten resin rapidly. As a result, since it becomes possible to cool and solidify the molten resin before crystals grow even when the thermoplastic resin is a crystalline polyolefin-based resin, it becomes possible to produce an optical thermoplastic resin film with high transparency.

The process for producing an optical thermoplastic resin film according to the present invention employs a metal cooling roll and a presser in which one or more rubber rolls are disposed inside a tubular metal belt. A resin mass (bank) is therefore greatly inhibited from being formed during pressing of the molten resin molded in a film form. As a result, orientation hardly occurs and it is possible to produce an optical thermoplastic resin film which has low phase difference, and has almost no phase difference irregularities in the width direction.

In the process for producing an optical thermoplastic resin film according to the present invention, the cooling roll and the belt of the presser are both made of metal. It is thus possible to form an optical thermoplastic resin film with excellent surface gloss.

In the cooling step of the process for producing an optical thermoplastic resin film according to the present invention, the surface temperature of the metal cooling roll T1 [° C.] is set so as to satisfy the condition represented by the above formula (1), and the surface temperature of the metal belt of the presser T2 [° C.] is set so as to satisfy the condition represented by the above formula (2). That is, the surface temperature of the metal belt of the presser T2 is set to be a higher temperature than the surface temperature of the metal cooling roll T1. The molten resin molded in a film form is therefore easily released from the presser, and defects such as wrinkles do not form in the film, resulting in a good film with a mirror surface. The case where T1 is lower than Tg −30° C. or the case where T1 is higher than Tg +50° C. is undesirable because, if so, there is a tendency that surface defects composed of transverse wrinkles occur in the film or the transparency of the film lowers. Also, the case where T2 is lower than T1 +10° C. or the case where T2 is higher than T1 +150° C. is undesirable because the molten resin molded in a film form will be less easily releasable from the presser and defects such as wrinkles will tend to be formed in a film.

### Effect of the Invention

According to the present invention, it is possible to provide a process for producing an optical thermoplastic resin film from which films with almost no orientation and high transparency can be obtained.

### BRIEF DESCRIPTION OF THE DRAWINGS

FIG. 1 is a block diagram showing an overview of a film production system according to an embodiment of the present invention.

FIG. 2 is a block diagram showing an overview of another example of a film production system according to an embodiment of the present invention.

FIG. 3 is a block diagram showing an overview of another example of a film production system according to an embodiment of the present invention.

FIG. 4 is a table showing the conditions for performing Examples 1-1 and 1-2 and Comparative Example 1-1, and the evaluation results thereof

FIG. 5 is a table showing the conditions for performing Examples 2-1 to 2-6 and Comparative Examples 2-1 and 2-2, and the evaluation results thereof.

### EXPLANATION OF SYMBOLS

1: Film production system, 12: T-shaped die, 12a: discharge slit, 14, 20, 28: touch rolls, 14a, 22: belts, 14b: rubber roll, 16, 18: cooling rolls, 30: cooling unit, F: thermoplastic resin film.

### BEST MODE FOR CARRYING OUT THE INVENTION

Preferred embodiments of the present invention will now be explained with reference to the accompanying drawings. Throughout the explanation, the same numerals will be used for identical or similarly functioning elements and will be explained only once.

(Configuration of Film Production System)

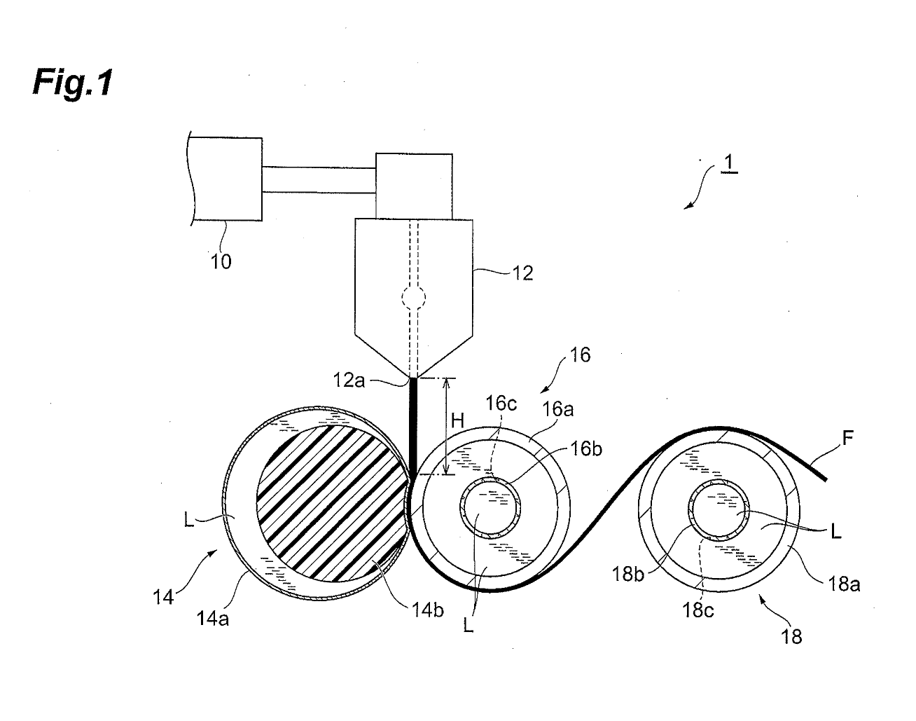

The configuration of the film production system 1 used for the process for producing an optical thermoplastic resin film according to this embodiment will be explained first, with reference to FIG. 1. The film production system 1 comprises an extruder 10, a T-shaped die 12, a touch roll (presser) 14 and cooling rolls 16, 18.

The extruder 10 melts and kneads the loaded thermoplastic resin while extruding it, and transports the melted and kneaded thermoplastic resin (molten resin) to the T-shaped die 12.

The T-shaped die 12 is connected to the extruder 10, and it internally has a manifold (not shown) that spreads the molten resin transported from the extruder 10 in the transverse direction. At the bottom section of the T-shaped die 12 there is provided a discharge slit 12a that is in communication with the manifold and discharges the molten resin that has been spread in the transverse direction by the manifold. The molten resin discharged from the discharge slit 12a of the T-shaped die 12 is thus formed into a film form.

The T-shaped die 12 is preferably one without minute level differences or nicks on the wall faces of the molten resin fluid channels. The discharge slit 12a section (lip section) of the T-shaped die 12 is preferably made of a material with a low frictional coefficient with the molten resin (the melted thermoplastic resin), and plated or coated with a hard material (such as a tungsten carbide-based or fluorine-based special plating), since this will allow the radius of curvature of the tip section of the discharge slit 12a to be reduced (the tip section of the discharge slit 12a can be formed as a sharp edge).

The tip section of the discharge slit 12a of the T-shaped die 12 preferably has a sharp edge shape wherein the radius of curvature at the discharge slit 12a located in the wall face of the molten resin fluid channels is not greater than 0.1 mm, and this radius of curvature is more preferably not greater than 0.05 mm and even more preferably not greater than 0.03 mm. Using such a T-shaped die 12 can inhibit T-shaped die drool at the discharge slit 12a while also having an effect of preventing die lines, thus resulting in superior uniformity of appearance for the produced optical thermoplastic resin film. However, a radius of curvature is 0.01 mm or smaller, while improving these effects, will lower the strength at the tip section of the discharge slit 12a and lead to damage of the discharge slit 12a, thus tending to produce notable die lines.

The length H of a distance from the molten resin discharge slit 12a of the T-shaped die 12 to the point where the molten resin is pressed by the touch roll 14 and cooling roll 16 (a so-called “air-gap”) is preferably about 50 mm to about 250 mm and more preferably about 50 mm to about 180 mm If the air-gap length H is greater than 250 mm, there is a tendency that an orientation takes place in the air-gap, so that the phase difference of the thermoplastic resin film F. The lower limit of the air-gap length H naturally is approximately 50 mm, though this will depend on the film production system 1 including the size of the T-shaped die 12 and the diameters of the touch roll 14 and the cooling roll 16, 18.

The touch roll 14 is equivalent to the forming roll described in Japanese Patent No. 3422798, for example. Specifically, the touch roll 14 comprises a tubular metal belt (also known as an “endless belt”) 14a, a rubber roll 14b disposed inside the belt 14a (one roll for this embodiment), a liquid L filling the space between the belt 14a and rubber roll 14b, and temperature adjusting means (not shown) of adjusting the temperature of the liquid L.

The belt 14a is formed into a tube from an elastic deformable metal thin-film such as spring steel, stainless steel or nickel steel, and it has no seam on its surface. Both sides of the belt 14a are occluded by an occluding member, which is not shown in the figure. The belt 14a used may have a thickness of about 100 μm to about 1500 μm, a diameter of about 200 mm to about 600 mm and a surface roughness of up to 0.5 S, preferably with a surface roughness of no greater than 0.2 S. The diameter of the belt 14a is set to an appropriate size for the processing speed of the thermoplastic resin film F (described hereafter), and a belt 14a diameter in the range specified above is suitable for a thermoplastic resin film F processing speed range of several m/min to 100 and several tens of m/min.

The rubber roll 14b has a cylindrical form, and it is elastically deformable and rotatable inside the belt 14a. The rubber roll 14b may be formed of EPDM (ethylene-propylene-diene rubber), Neoprene or silicone having a hardness of about 30-90. The rubber roll 14b may have a diameter of about 100 mm-250 mm.

As a liquid L, for example, water, ethylene glycol or oil, may be used. Adjustment of the temperature of the liquid L by the temperature adjusting means (not shown), the surface temperature of the belt 14a may be adjusted indirectly.

The cooling roll 16 comprises a highly rigid metal outer cylinder 16a, a fluid axis cylinder 16b disposed inside the metal outer cylinder 16a, a liquid L filling the space between the metal outer cylinder 16a and the fluid axis cylinder 16b and the interior of the fluid axis cylinder 16b, and temperature adjusting means (not shown) for adjusting the temperature of the liquid L. The cooling roll 18 comprises a highly rigid metal outer cylinder 18a, a fluid axis cylinder 18b disposed inside the metal outer cylinder 18a, a liquid L filling the space between the metal outer cylinder 18a and the fluid axis cylinder 18b and the interior of the fluid axis cylinder 18b, and temperature adjusting means (not shown) for adjusting the temperature of the liquid L. The cooling rolls 16, 18 may have diameters of about 200 mm to about 600 mm and mirror surfaces with a surface roughness of no greater than 0.2 S.

In the cooling rolls 16, 18, the temperature of the liquid L is adjusted by the temperature adjusting means (not shown) like in the touch roll 14, and thereby the surface temperatures of the metal outer cylinders 16a, 18a are indirectly adjusted and the molten resin film discharged from the discharge slit 12a of the T-shaped die 12 is cooled and solidified thereby with the touch roll 14.

The molten resin film are solidified by the touch roll 14 and cooling rolls 16, 18, a thermoplastic resin film F is produced. The thermoplastic resin film is used as the optical thermoplastic resin film either directly or after subsequent stretching.

The processing speed for the thermoplastic resin film F increases with more rapid cooling and solidification of the molten resin, or in other words, with increasing diameter of the cooling roll 16 used as the casting roll. Specifically, with a cooling roll 16 diameter of 600 mm, the processing speed for the thermoplastic resin film F can be set to a maximum of about 50 m/min and normally about 30 m/min.

The touch roll 14 and the cooling rolls 16, 18 will usually be arranged in a row below the T-shaped die 12. Specifically, the touch roll 14 and the cooling roll 16 are disposed at a prescribed spacing, and the thickness of the crystalline polyolefin-based resin film F will be depend on the spacing between the touch roll 14 and the cooling roll 16, or on the rotational speeds of the rolls 14, 16, 18 and the throughput of molten resin discharged from the discharge slit 12a of the T-shaped die 12. For this embodiment, the touch roll 14 is comprised of the rubber roll 14b disposed inside the belt 14a, pressing of the molten resin between the touch roll 14 and cooling roll 16 causing contact bonding of the rubber roll 14b with the cooling roll 16 through the belt 14a and molten resin, and therefore the elasticity of the rubber roll 14b allows the pressing length of the molten resin defined by the touch roll 14 and cooling roll 16 to be 3 mm or longer (for example, about 3 mm to about 120 mm).

When a propylene-based resin is used as the thermoplastic resin, preferably the thickness of the belt 14a is about 350 μm to about 500 μm and the hardness of the rubber roll 14b is about 60 to about 75. If the thickness of the belt 14a is less than 350 μm and the hardness of the rubber roll 14b is less than 60, the elasticity of the touch roll 14 will be too low making it difficult to accomplish uniform pressing in the widthwise direction of the touch roll 14. If the thickness of the belt 14a exceeds 500 μm and the hardness of the rubber roll 14b exceeds 75, the rigidity of the touch roll 14 will be too great, tending to weaken the effect of soft pressing.

(Thermoplastic Resin)

Examples of thermoplastic resins to be used for production of the optical thermoplastic resin film for this embodiment (thermoplastic resin film F) include homopolymers of olefins such as ethylene, propylene, butene, hexene and cyclic olefins, or copolymers of two or more olefins, polyolefin-based resins that are copolymers of one or more olefins and one or more polymerizable monomers that are polymerizable with olefins, acrylic-based resins such as polymethyl acrylate, polymethyl methacrylate and ethylene/ethyl acrylate copolymer, styrene-based resins such as butadiene/styrene copolymer, acrylonitrile/styrene copolymer, polystyrene, styrene/butadiene/styrene copolymer, styrene/isoprene/styrene copolymer and styrene/acrylic acid copolymer, vinyl fluoride-based resins such as vinyl chloride-based resin, polyvinyl fluoride and polyvinylidene fluoride, amide-based resins such as 6-nylon, 6,6-nylon and 12-nylon, saturated esteric resins such as polyethylene terephthalate and polybutylene terephthalate, polycarbonates, polyphenylene oxides, polyacetals, polyphenylene sulfides, silicone resins, thermoplastic urethane resins, polyether ether ketones, polyetherimides, thermoplastic elastomers, and crosslinked forms of the foregoing. The thermoplastic resin may be a blend of two or more different thermoplastic resins, and may contain additives as appropriate.

In the thermoplastic resins mentioned above, polyolefin-based resins are most preferable to use since they are satisfactory for optical film purposes because of their excellent recycling properties and solvent resistance and because they do not generate dioxins when incinerated and therefore are not detrimental to the environment, while polypropylene-based resins are more preferable among crystalline polyolefin-based resins from the standpoint of heat resistance.

(Polyolefin-based Resin)

Polyolefin-based resins include homopolymers of olefins such as ethylene, propylene, butene, hexene and cyclic olefins, or copolymers of two or more olefins, or copolymers of one or more olefins and one or more polymerizable monomers that are polymerizable with olefins, any of which may also be further modified after polymerization. The polyolefin-based resin may be a blend of two or more different polyolefin-based resins, and it may appropriately contain resins other than polyolefin-based resins or additives.

Examples of olefins for polyolefin-based resins include ethylene, propylene, α-olefins including 4-20 carbon atoms, cyclic olefins and the like.

Specific α-olefins include 1-butene, 2-methyl-1-propene, 1-pentene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3 -dimethyl-1-butene, 1-heptene, 2-methyl-1-hexene, 2,3-dimethyl-1-pentene, 2-ethyl-1-pentene, 2-methyl-3-thyl-1-butene, 1-octene, 2-ethyl-1-hexene, 3,3-dimethyl-1-hexene, 2-propyl-1-heptene, 2-methyl-3 -ethyl-1-heptene, 2,3 ,4-trimethyl-1-pentene, 2-propyl-1-pentene, 2,3 -diethyl-1-butene, 1-nonene, 1 -decene, 1-undecene, 1-dodecene, 1-tridecene, 1-tetradecene, 1-pentadecene, 1-hexadecene, 1-heptadecene, 1-octadecene and 1-nonadecene.

Examples of cyclic olefins include bicyclo[2.2.1]hept-2-ene, commonly known as norbornane, norbornane derivatives having 1 - 4 carbon atoms alkyl groups such as methyl, ethyl or butyl groups introduced, such as 6-alkylbicyclo[2.2.1]hept-2-ene, 5,6-dialkylbicyclo [2.2.1]hept-2-ene, 1-alkylbicyclo [2.2 .1]hept-2-ene and 1-alkylbicyclo [2.2.1]hept-2-ene, tetracyclo [4.4.0.1^{2,5}.1^{7,10}]-3-decene, also known as dimethanooctahydronaphthalene, dimethanooctahydronaphthalene derivatives having three or more carbon atoms alkyl groups introduced at the 8 and/or 9 positions of dimethanooctahydronaphthalene, such as 8-alkyltetracyclo[4.4.0.1^{2,5}.1^{7,10}]-3-dodecene and 8,9-dialkyltetracyclo[4.4.0.1^{2,5}.1^{7,10}]-3-dodecene, and also norbornane derivatives having one or more halogens introduced into the molecule and dimethanooctahydronaphthalene derivatives having halogens introduced at the 8 and/or 9 position.

Examples of the one or more polymerizable monomers that are polymerizable with olefins include aromatic vinyl compounds, alicyclic vinyl compounds such as vinylcyclohexane, polar vinyl compounds and polyene compounds.

Aromatic vinyl compounds include styrene and its derivatives, styrene derivatives including compounds having other substituents bonded to styrene, and examples thereof include alkylstyrenes such as o-methylstyrene, m-methylstyrene, p-methylstyrene, 2,4-dimethylstyrene, o-ethylstyrene and p-ethylstyrene, substituted styrenes having a hydroxyl, alkoxy, carboxyl, acyloxy, halogen or the like introduced onto the benzene ring of styrene, such as hydroxystyrene, t-butoxystyrene, vinylbenzoic acid, vinylbenzyl acetate, o-chlorostyrene and p-chlorostyrene, vinylbiphenyl-based compounds such as 4-vinylbiphenyl and 4-hydroxy-4′-vinylbiphenyl, vinylnaphthalene-based compounds such as 1-vinylnaphthalene and 2-vinylnaphthalene, vinylanthracene compounds such as 1-vinylanthracene and 2-vinylanthracene, vinylpyridine compounds such as 2-vinylpyridine and 3-vinylpyridine, vinylcarbazole compounds such as 3-vinylcarbazole, and acenaphthylene compounds.

Examples of polar vinyl compounds include acrylic compounds such as methyl acrylate, methyl methacrylate and ethyl acrylate, or vinyl acetate, vinyl chloride and the like.

Examples of polyene compounds include conjugated polyene compounds and nonconjugated polyene compounds. Examples of conjugated polyene compounds include aliphatic conjugated polyene compounds and alicyclic conjugated polyene compounds, and examples of nonconjugated polyene compounds include aliphatic nonconjugated polyene compounds, alicyclic nonconjugated polyene compounds and aromatic nonconjugated polyene compounds. These may be optionally substituted with substituents such as alkoxy, aryl, aryloxy, aralkyl and aralkyloxy.

Specific examples of polyolefin-based resins include polyethylene-based resins such as low-density polyethylene, linear polyethylene, (ethylene-α-olefin copolymers) and high-density polyethylene, polypropylene-based resins such as polypropylene, propylene-ethylene copolymer and propylene-1-butene copolymer copolymer, ethylene-cyclic olefin copolymers, ethylene-vinylcyclohexane copolymer, poly(4-methylpentene-1), poly(butene-1), ethylene-methyl acrylate copolymer, ethylene-methyl methacrylate copolymer, ethylene-ethyl acrylate copolymer and ethylene-vinyl acetate copolymer.

Examples of modified polyolefin-based resins include crystalline polyolefin-based resins modified with modifying compounds such as maleic anhydride, dimethyl malate, diethyl malate, acrylic acid, methacrylic acid, tetrahydrophthalic acid, glycidyl methacrylate and hydroxyethyl methacrylate.

(Polypropylene-Based Resin)

The polypropylene-based resin may be propylene homopolymer or a copolymer of propylene with one or more monomers selected from the group consisting of ethylene and α-olefins including 4-20 carbon atoms. Blends of the foregoing may also be used. Preferred from the viewpoint of obtaining the effect of the present invention more prominently are propylene homopolymer, propylene-ethylene copolymer, propylene-1-butene copolymer, propylene-1-pentene copolymer, propylene-1-hexene copolymer, propylene-1-octene copolymer, propylene-ethylene-1-butene copolymer and propylene-ethylene-1-hexene copolymer. When the polypropylene-based resin of the present invention is a copolymer of propylene with one or more monomers selected from the group consisting of ethylene and α-olefins including 4-20 carbon atoms, it may be a random copolymer or a block copolymer.

When the polypropylene-based resin is a copolymer, the content of the comonomer-derived structural unit in the copolymer is preferably greater than 3 wt % and no greater than 40 wt % from the viewpoint of balance between transparency and heat resistance. From the same viewpoint, it is more preferably greater than 5 wt % and 25 wt %. In the case of a copolymer of two or more comonomers with propylene, the total of all the comonomer structural units in the copolymer is preferably within the range specified above.

The process for producing the polypropylene-based resin may be a method of homopolymerization of propylene using a known polymerization catalyst, or a method of copolymerization of propylene with one or more monomers selected from the group consisting of ethylene and α-olefins including 4-20 carbon atoms. Examples of known polymerization catalysts include (1) Ti—Mg catalysts composed of solid catalyst components comprising magnesium, titanium and halogens as essential components, (2) catalyst systems that are combinations of solid catalyst components comprising magnesium, titanium and halogens as essential components, with organic aluminum compounds and if necessary third components such as electron-releasing compounds, and (3) metallocene-based catalysts.

Among these, catalyst systems used for production of propylene-based copolymers are most commonly catalyst systems that are combinations of organic aluminum compounds and electron-releasing compounds with solid catalyst components comprising magnesium, titanium and halogens as essential components. More specifically, preferred organic aluminum compounds include triethylaluminum, triisobutylaluminum, mixtures of triethylaluminum and diethylaluminum chloride, and tetraethyldialuminoxane, while preferred electron-releasing compounds include cyclohexylethyldimethoxysilane, tert-butyl-n-propyldimethoxysilane, tert-butylethyldimethoxysilane and dicyclopentyldimethoxysilane. Examples of solid catalyst components comprising magnesium, titanium and halogens as essential components include the catalysts systems described in Japanese Unexamined Patent Application Publication Nos. 61-218606, 61-287904 and 7-216017. Examples of metallocene catalysts include the catalyst systems described in Japanese Patent Nos. 2587251, 2627669 and 2668732.

The polymerization process used for production of the polypropylene-based resin may be solvent polymerization using an inactive solvent which is typically a hydrocarbon compound such as hexane, heptane, octane, decane, cyclohexane, methylcyclohexane, benzene, toluene or xylene, bulk polymerization using a liquid monomer as the solvent or vapor-phase polymerization carried out in a gaseous monomer, but bulk polymerization and vapor-phase polymerization are preferred. These polymerization processes may be either batch processes or continuous processes.

The tacticity of the polypropylene-based resin may be isotactic, syndiotactic or atactic. The polypropylene-based resin is preferably a syndiotactic or isotactic propylene-based copolymer from the viewpoint of heat resistance.

The polypropylene-based resin may also be a blend of two or more polypropylene-based polymers with different molecular weights, propylene structural unit ratios or tacticities, and it may contain polymers other than the polypropylene-based polymer or additives as appropriate.

(Additives)

The thermoplastic resin used for this embodiment may contain known additives in ranges that do not interfere with the effect of the present invention.

Examples of additives include antioxidants, ultraviolet absorption materials, antistatic agents, lubricants, nucleating agents, anti-fogging agents, and anti-blocking agents, among which any two or more may also be used in combination.

Antioxidants include phenol-based antioxidants, phosphorus-based antioxidants, sulfur-based antioxidants, hindered amine-based antioxidants (HALS), and compound antioxidants having, for example, a unit with a phenol-based and phosphorus-based antioxidant mechanism in the molecule.

Ultraviolet absorbers include ultraviolet absorbers such as 2-hydroxybenzophenone-based and hydroxytriazole-based, and ultraviolet blockers such as benzoate-based compounds.

Antistatic agents include polymer, oligomer and monomer agents.

Lubricants include higher fatty acid amides such as erucic acid amide and oleic acid amide, higher fatty acids such as stearic acid, and metal salts of the foregoing.

Examples of nucleating agents include sorbitol-based nucleating agents, organic phosphoric acid salt-based nucleating agents, and polymer-based nucleating agents such as polyvinylcycloalkane. An anti-blocking agent may be used as spherical or nearly spherical fine particles, whether inorganic or organic.

(Molecular Weight)

The melt flow rate (MFR) of the thermoplastic resin used for this embodiment is the value measured in accordance with JIS K 7210 (with testing temperature and nominal load as in Table 1 of Appendix B to JIS K 7210), and it is normally about 0.1 g/10 min to about 50 g/10 min and preferably about 0.5 g/10 min to about 20 g/10 min. Using a propylene-based resin with an MFR in this range will allow a uniform film to be formed without large load on the extruder 10.

(Molecular Weight Distribution)

The molecular weight distribution of the thermoplastic resin used for this embodiment will normally be 1 to about 20. The molecular weight distribution is the ratio of Mw to Mn (=Mw/Mn), as calculated with measurement using 140° C. o-dichlorobenzene as the solvent and polystyrene as the reference sample.

(Process for Producing Optical Film made of Thermoplastic Resin)

A process for producing an optical thermoplastic resin film by the film production system 1 described above will now be explained with reference to FIG. 1.

First, the thermoplastic resin is loaded into the extruder 10 through a hopper (not shown) (melting step). In order to inhibit deterioration of the resin, it is preferred to carry out pre-drying in nitrogen at a temperature of 40° C. or higher and (Tm −20° C.) or lower for about 1 to about 10 hours before supplying the thermoplastic resin to the extruder 10 (where Tm [° C.] is the melting peak temperature in differential scanning calorimetry in accordance with JIS K 7121). The gas in the extruder 10 is also preferably replaced with an inert gas such as nitrogen gas or argon gas at 20° C. to 120° C. When impurities or contaminants are a problem, a filter unit such as a leaf disk filter may be used as necessary.

Next, the thermoplastic resin is melted and kneaded with the screw in the cylinder of the extruder 10 that has been heated to a temperature of 180° C. or higher and 300° C. or lower, and the molten resin molded in a film form is thus discharged from the discharge slit 12a of the T-shaped die 12 at 180° C. or higher and 300° C. or lower (molding step). The temperature of the molten resin is measured using a resin thermometer at the discharge slit 12a of the T-shaped die 12.

A molten resin temperature of below 180° C. will tend to result in insufficient spreadability of the resin, leading to thickness irregularities caused by uneven elongation in the air-gap. A molten resin temperature of above 300° C. will tend to degrade the resin, and contaminate the lip section because of generation of decomposition gas and cause die, resulting in outer appearance defects in the film. For this reason, the molten resin temperature is preferably 220° C. or higher and 280° C. or lower.

The molten resin in a film form is then pressed by the touch roll 14 and cooling roll 16 while being cooled and solidified by the touch roll 14 and cooling rolls 16, 18, to obtain a thermoplastic resin film F (cooling step). During this time, the touch roll 14 is pressed inward by the cooling roll 16 and the belt 14a and the rubber roll 14b disposed inside the belt 14a are both deformed. The surface temperature of the cooling roll 16 T1 [° C.] is set so as to satisfy the condition represented by the following formula (3), while the surface temperature of the belt 14a of the touch roll 14 T2 [° C.] is set so as to satisfy the condition represented by the following formula (4).

Tg−30° C.≦T1≦Tg+50° C. (3)

(Tg [° C.] is the intermediate point glass transition temperature of the thermoplastic resin.)

T1+10° C.≦T2≦T1+150° C. (4)

If Ti is lower than Tg −30° C. or higher than Tg +50° C., transverse wrinkles may occur as surface defects in the film, thus tending to lower the transparency of the film. Also, if T2 is lower than T1+10° C. or higher than T1+150° C., the molten resin that has been molded in a film form will be less easily releasable from the presser and defects such as wrinkles will tend to form in the film. More preferably, the surface temperature of the cooling roll 16 T1[° C.] is set so as to satisfy the condition represented by the following formula (5), while the surface temperature of the belt 14a of the touch roll 14 T2 [° C.] is set so as to satisfy the condition represented by the following formula (6).

Tg−10° C.≦T1≦Tg+30° C. (5)

T1+10° C.≦T2≦T1+120° C. (6)

Tg is determined according to JIS K 7121, and specifically it is determined by using a differential scanning calorimeter (DSC) or the like, from the curvature inflection point of the DSC curve obtained by the process that the sample first heated to above the melting point and then cooled at the prescribed rate to about −30° C. (for PP (polypropylene)), with measurement conducted while subsequently raising the temperature at the prescribed rate.

The pressing pressure (linear pressure) depends on the pressure with which the touch roll 14 is pressed against the cooling roll 16, and it is preferably about 0.1 N/mm to about 20 N/mm and more preferably about 0.5 N/mm to about 10 N/mm. If the linear pressure is less than 0.1 N/mm, it will tend to be difficult to uniformly control the linear pressure on the molten resin. If the linear pressure is greater than 20 N/mm, the molten resin will be pressed too strongly and as a result the molten resin will form a bank as it collects on the pressed (nip) section, tending to cause significant phase difference to be exhibited.

Common methods for controlling the pressing pressure (linear pressure) include (1) a method of placing a triangular wedge-shaped “filler block”, known as a cotter, at the pressing (nip) section, and adjusting the cotter to modify the roll spacing, or (2) pressing both the touch roll 14 and cooling roll 16 against a cotter adjusted to a prescribed pressure using oil pressure, air or the like. Instead of using a cotter, the rotational speed of the screw may be controlled for mechanical contact bonding to a prescribed point without level differences, or a servomotor may be used in an oil pressure system.

The thermoplastic resin film F is then taken up with a winder, with slitting (cutting) of the tab section if necessary, as an optical thermoplastic resin film or as the raw film for a pre-stretching optical film (retardation film). Either before or after slitting (cutting) of the tab section of the thermoplastic resin film F, a protective film may be layered on one or both sides of the thermoplastic resin film F.

The thickness of the optical thermoplastic resin film is preferably about 20 μm to about 500 μm from the viewpoint of more satisfactorily exhibiting the effect of the present invention, although this range is not particularly restrictive. That is, the thickness of the optical thermoplastic resin film may be any thickness necessary for a retardation film for different purposes, obtained by stretching under different stretching conditions. The stretching method may be longitudinal stretching, transverse stretching, sequential biaxial stretching or simultaneous biaxial stretching For sequential biaxial stretching, transverse stretching may be carried out after longitudinal stretching, or longitudinal stretching may be carried out after transverse stretching.

The optical thermoplastic resin film produced by the steps described above, having its phase difference controlled by stretching, can be utilized as a retardation film for use in liquid crystal panels with a wide range of sizes, for television sets, personal computer monitors, car navigation systems, digital cameras, cellular phones and the like.

Furthermore, because it is non-oriented and highly transparent it can also be used as a polarizing plate protective film, as well as for various types of liquid crystal members.

Incidentally, polarizing plate protective films and raw films for retardation films must be non-oriented. “Non-oriented” means a disordered state without any orientation of the molecular chains of the polymer in the material of the thermoplastic resin. The degree of orientation can be evaluated on the basis of the phase difference value, and the phase difference value can be measured using a commercially available phase difference meter. The phase difference value for a raw film for the retardation film is preferably about 0 nm to about 50 nm with a thickness of 100 μm. If the phase difference value of the raw film for the retardation film is outside of this range, it will be difficult to control the phase difference when the raw film for the retardation film is stretched into a retardation film, even if the stretching conditions are modified, because of the initial phase difference of the raw film for the retardation film, and this will tend to result in phase difference irregularities and impairment of display uniformity when it is incorporated into a liquid crystal panel, and hence lower product value. Also, if the phase difference value of a polarizer protective film is outside of the ranges specified above, the display uniformity will likewise be impaired when it is incorporated into a liquid crystal panel, thus lowering the product value.

In the embodiment described above, the molten resin molded in a film form is pressed between the metal cooling roll 16 and the touch roll 14 in which one rubber roll 14b are disposed inside a tubed metal belt 14a. Thus, since the both surfaces of the molten resin molded in a film form is cooled by the touch roll 14 and the cooling roll 16 (casting roll), it is possible to cool and solidify the molten resin rapidly. As a result, since it becomes possible to cool and solidify the molten resin before crystals grow even when the thermoplastic resin is a crystalline polyolefin-based resin, it becomes possible to produce an optical thermoplastic resin film with high transparency.

Also, the embodiment described above employs a metal cooling roll 16 and the touch roll 14 in which one or more rubber rolls 14b are disposed inside a tubed metal belt 14a. A resin mass (bank) is therefore greatly inhibited from being formed during pressing of the molten resin molded in a film form. As a result, orientation hardly occurs and it is possible to produce an optical thermoplastic resin film, which has low phase difference, and has almost no phase difference irregularities in the width direction. Therefore, the effect of the present invention is exhibited most prominently when using a crystalline polyolefin-based resin because it is highly susceptible to loss of optical homogeneity and is approximately 100 times more easily oriented than amorphous polyolefin-based resin.

Also, the belt 14a of the touch roll 14 and the cooling roll 16 of this embodiment are both made of metal. It is thus possible to form an optical thermoplastic resin film with excellent surface gloss.

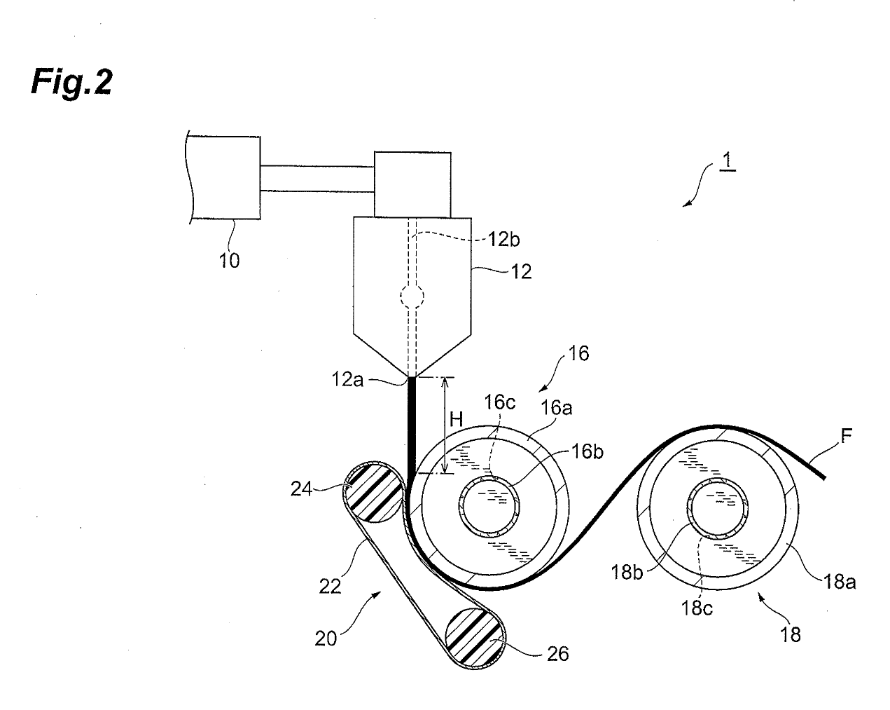

The above detailed explanation of a preferred embodiment of the present invention is not intended to restrict the scope of the present invention to this particular embodiment. For example, a touch roll 20 as shown in FIG. 2 may be used instead of the touch roll 14. The touch roll 20 is equivalent to the molding belt means described in Japanese Unexamined Patent Application Publication No. 7-040370. Specifically, the touch roll 20 comprises a tubular metal belt (or “endless belt”) 22, two rolls 24, 26 disposed within the belt 22 along the peripheral surface of the cooling roll 16 and parallel in their lengthwise directions, and temperature adjusting means (not shown) for adjustment of the surface temperature of the belt 22, where the roll 24 is a rubber roll according to the present invention, the roll 26 is a metal roll, and the surface temperature of the belt 22 is adjusted by adjusting the surface temperature of the roll 26 with the temperature adjusting means.

The belt 22 is formed into a tube from an elastic deformable metal thin-film such as spring steel, stainless steel or nickel steel, and it has no seam on its surface. The belt 22 is wrapped across the rubber roll 24 and the metal roll 26, and increasing or decreasing the distance between the rolls 24, 26 allows the tension of the belt 22 to be adjusted. The belt 22 may have a thickness of about 300 μm to about 800 μm and a diameter of about 200 mm to about 600 mm as a cylindrical loop, and preferably the surface roughness is no greater than 0.2 S.

The rolls 24, 26 each have a cylindrical form, and are rotatable inside the belt 22. The rubber roll 24 may be formed of EPDM (ethylene-propylene-diene rubber), Neoprene or silicone having a hardness of about 30 to about 90. The rolls 24, 26 may each have a diameter of about 80 mm to about 200 mm.

When a touch roll 20 is used, the location where the molten resin discharged from the discharge slit 12a of the T-shaped die 12 is first nipped by the belt 22 and the cooling roll 16 is the pressing start point, and the location where the molten resin is subsequently released from between the belt 22 and the cooling roll 16 is the pressing end point.

When a propylene-based resin is used as the thermoplastic resin, preferably the thickness of the belt 22 is about 350 μm to about 600 μm and the hardness of the rubber roll 24 is about 60 to about 80. If the thickness of the belt 22 is less than 350 μm and the hardness of the rubber roll 24 is less than 60, the elasticity of the touch roll 14 will be too low, making it difficult to accomplish uniform pressing in the widthwise direction of the touch roll 14. If the thickness of the belt 22 exceeds 600 μm and the hardness of the rubber roll 24 exceeds 80, the rigidity of the touch roll 14 will be too great, tending to form a bank and increasing the probability of creating a phase difference.

Even when using the touch roll 20 and cooling roll 16 described above, the surface temperature of the cooling roll 16 T1 [° C.] is set so as to satisfy the condition represented by the above formula (3), while the surface temperature of the belt 22 of the touch roll 20 T2 [° C.] is set so as to satisfy the condition represented by the above formula (4).

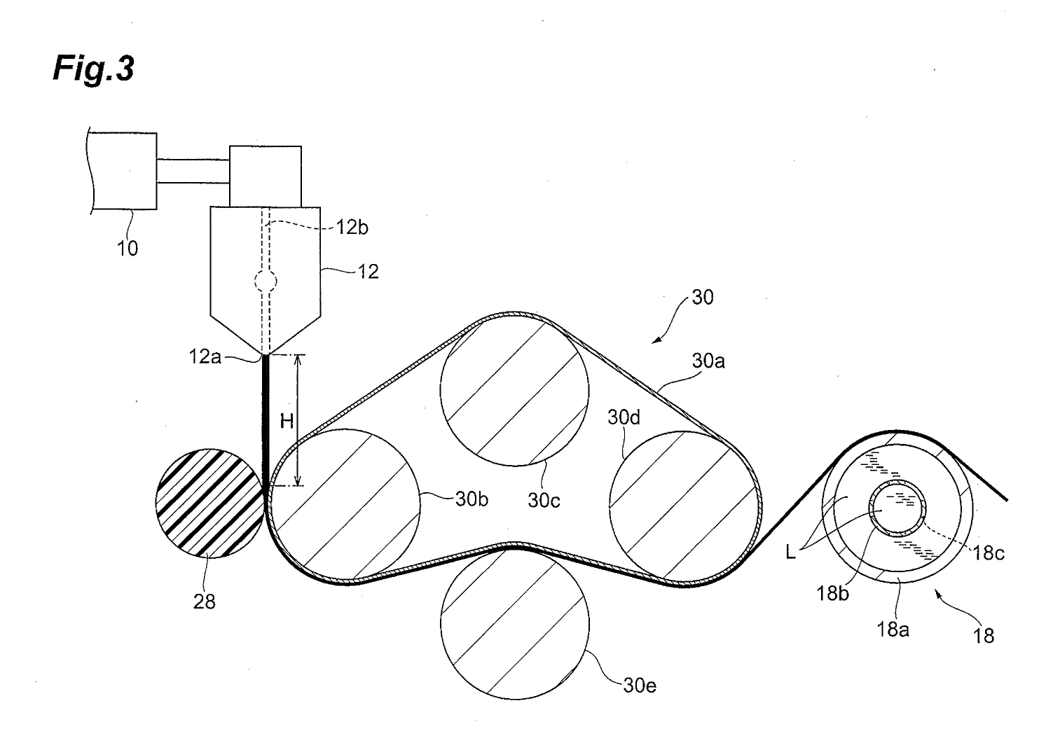

Also, a touch roll 28 as shown in FIG. 3 may be used instead of the touch roll 14, and a cooling unit 30 as shown in FIG. 3 may be used instead of the cooling roll 16. The touch roll 28 has a cylindrical shape. The touch roll 28 may be a rubber roll formed from neoprene or silicone with a hardness of about 30 to about 90, or a metal roll with a surface roughness of no greater than 0.2 S. The touch roll 28 may have a diameter of about 200 mm to about 600 mm.

The cooling unit 30 comprises a tubular metal belt 30a, a plurality of rolls 30b-30d (three in this case) within the belt 30a and supporting the belt 30a, a roll 30d outside of the belt 30a and supporting the belt 30a, and temperature adjusting means (not shown) for adjustment of the surface temperature of the belt 30a.

The belt 30a is formed into a tube from an elastic deformable metal thin-film such as spring steel, stainless steel or nickel steel, and it has no seam on its surface. The belt 30a may have a thickness of about 800 μm to about 1200 μm and a diameter of about 2 to about 10 m as a cylindrical loop, and preferably the surface roughness is no greater than 0.5 S.

The rolls 30b-30d each have a cylindrical shape. Also, the rolls 30b-30d may each have a diameter of about 800 mm to about 1200 mm.

Even when using the touch roll 28 and cooling unit 30 described above, the surface temperature of the belt 30a of the cooling unit 30 T1 [° C.] is set so as to satisfy the condition represented by the above formula (3), while the surface temperature of the touch roll 28 T2 [° C.] is set so as to satisfy the condition represented by the above formula (4).

### EXAMPLE 1

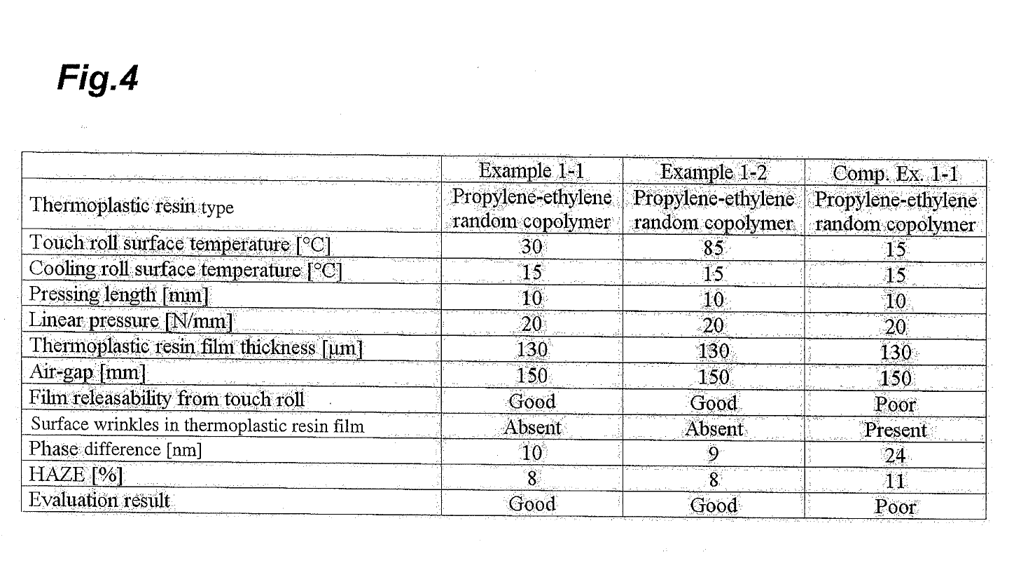

The present invention will now be explained in greater detail based on Examples 1-1 and 1-2 and Comparative Example 1-1 and FIGS. 1 and 4, with the understanding that these examples are in no way limitative on the present invention.

### EXAMPLE 1-1

A propylene-based resin (propylene-ethylene random copolymer, ethylene content=4 wt %, MFR=2, Tg=−10° C.) was melted and kneaded with a 50 paw extruder 10 (screw: L/D=32, barrier-type screw) heated to 250° C. and then fed from the extruder 10 to an adapter and T-shaped die 12 (both set to 250° C.) installed after the extruder 10, in that order, and a molten propylene-based resin film (molten resin) was discharged from the discharge slit (lip opening) 12a of the T-shaped die 12. The temperature of the molten resin at the discharge slit 12a section of the T-shaped die 12 was 248° C. The molten resin was pressed between the touch roll 14 and cooling roll 16 shown in FIG. 1 with a pressing length of 10 mm and a linear pressure of 20 N/mm while being cooled and solidified by the touch roll 14 and cooling rolls 16, 18, to obtain thermoplastic resin film F with a thickness of 130 μm.

The belt 14a of the touch roll 14 had a diameter of 280 mm, a thickness of 400 μm and a surface roughness of 0.4 S. The cooling rolls 16, 18 each had a diameter of 300 mm, a surface roughness of 0.1 S and a mirror surface. The rotational speed of the touch roll 14 was set to 3 m/min, the rotational speed of the cooling rolls 16, 18 was set to 3 m/min, the air-gap H was set to 150 mm, the surface temperature T1 of the cooling roll 16 was set to 15° C., and the surface temperature T2 of the belt 14a of the touch roll 14 was set to 30° C.

### EXAMPLE 1-2

Thermoplastic resin film F for Example 1-2 was obtained in the same manner as Example 1-1, except that the surface temperature T2 of the belt 14a of the touch roll 14 was set to 85° C.

### Comparative Example 1-1

Thermoplastic resin film F for Comparative Example 1-1 was obtained in the same manner as Example 1-1, except that the surface temperature T2 of the belt 14a of the touch roll 14 was set to 15° C.

(Evaluation Results)

During production of each thermoplastic resin film F of Examples 1-1 and 1-2, the thermoplastic resin film F released cleanly from the touch roll 14 and the molding stability was satisfactory. Also, upon visual observation of the thermoplastic resin films F obtained in Examples 1-1 and 1-2, the surface of each thermoplastic resin film F was free of wrinkles and the surface condition was satisfactory. When each of the thermoplastic resin films F of Examples 1-1 and 1-2 was cut to 40 mm×40 mm and the phase difference thereof measured with a KOBRA-WPR by Oji Scientific Instruments Co., Ltd., the phase differences were found to be 10 nm and 9 nm, respectively, which were sufficiently small values. Also, when each of the thermoplastic resin films F of Examples 1-1 and 1-2 was cut to 50 mm×50 mm and the haze measured according to JIS K 7136 using a haze meter by Suga Test Instruments Co., Ltd., both values were 8% indicating excellent transparency. The haze is an index of the film transparency, and a smaller value indicates higher transparency. Thus, the quality of the thermoplastic resin films F obtained in Examples 1-1 and 1-2 were both evaluated as “G: Good”.

On the other hand, during production of the thermoplastic resin film F of Comparative Example 1-1, the thermoplastic resin film F was poorly releasable from the touch roll 14 and the molding stability was unsatisfactory. Upon visual observation of the thermoplastic resin film F obtained in Comparative Example 1, the surface of the thermoplastic resin film F was found to contain wrinkles and the surface condition was unsatisfactory. When the thermoplastic resin film F of Comparative Example 1-1 was cut to 40 mm×40 mm and the phase difference thereof measured with a KOBRA-WPR by Oji Scientific Instruments Co., Ltd., the phase difference was found to be 24 nm, which was a larger value compared to Examples 1-1 and 1-2. Also, the haze of the thermoplastic resin film F obtained in Comparative Example 1-1 measured according to JIS K 7136 was 11%, which indicated poor transparency compared to Examples 1-1 and 1-2. Thus, the quality of the thermoplastic resin film F obtained in Comparative Example 1-1 was evaluated as “P: Poor”.

### EXAMPLE 2

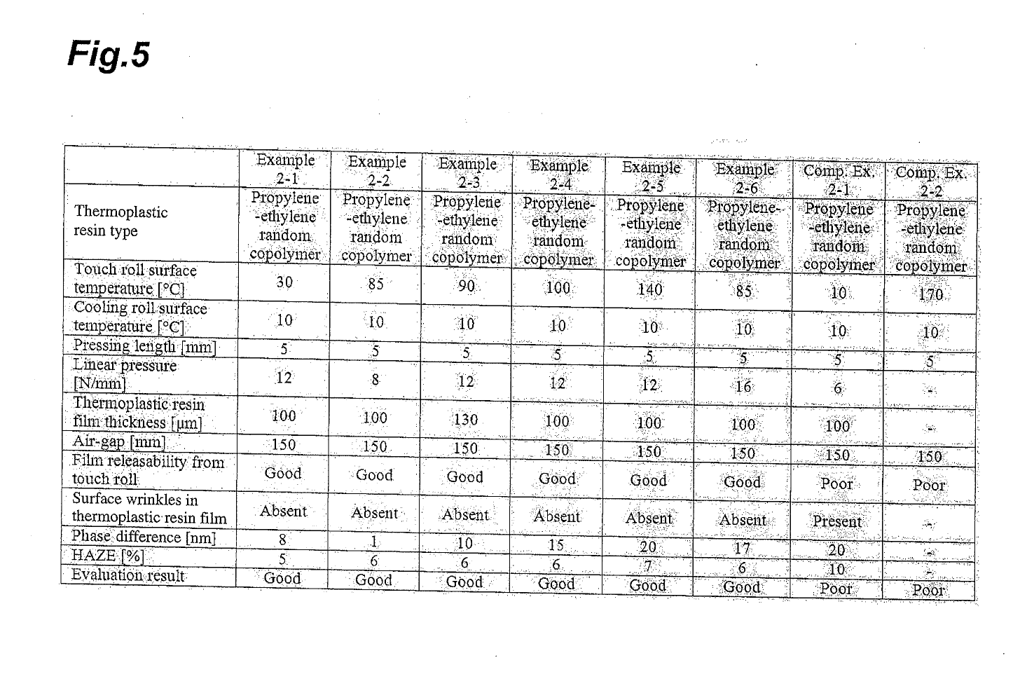

The present invention will now be explained in greater detail based on Examples 2-1 to 2-6 and Comparative Examples 2-1 and 2-2 and FIGS. 2 and 5, with the understanding that these examples are in no way limitative on the present invention.

### EXAMPLE 2-1

A propylene-based resin (propylene-ethylene random copolymer, ethylene content=4 wt %, MFR=2, Tg=−10° C.) was melted and kneaded with a 50 paw extruder 10 (screw: L/D=32, barrier-type screw) heated to 250° C. and then fed from the extruder 10 to an adapter and T-shaped die 12 (both set to 250° C.) installed after the extruder 10, in that order, and a molten propylene-based resin film (molten resin) was discharged from the discharge slit (lip opening) 12a of the T-shaped die 12. The temperature of the molten resin at the discharge slit 12a section of the T-shaped die 12 was 248° C. The molten resin was pressed between the touch roll 20 and cooling roll 16 shown in FIG. 2 with a pressing length of 5 mm and a linear pressure of 12 N/mm while being cooled and solidified by the touch roll 20 and cooling rolls 16, 18, to obtain thermoplastic resin film F with a thickness of 100 μm.

The belt 22 of the touch roll 20 had a diameter of 280 mm as a cylindrical loop, a thickness of 300 μm and a surface roughness of 0.2 S. The roll 24 of the touch roll 20 was formed of silicone, the roll 26 was a metal roll, both had diameters of 160 mm, and the hardness of the roll 24 was 60. The cooling rolls 16, 18 each had a diameter of 300 mm, a surface roughness of 0.1 S and a mirror surface. The rotational speed of the touch roll 20 was set to 5 m/min, the rotational speed of the cooling rolls 16, 18 was set to 5 m/min, the air-gap H was set to 150 mm, the surface temperature T1 of the cooling roll 16 was set to 10° C., and the surface temperature T2 of the belt 22 of the touch roll 20 was set to 30° C.

### EXAMPLE 2-2

Thermoplastic resin film F for Example 2-2 was obtained in the same manner as Example 2-1, except that the pressing was with a linear pressure 8 N/mm and the surface temperature T2 of the belt 22 of the touch roll 20 was set to 85° C.

### EXAMPLE 2-3

Thermoplastic resin film F for Example 2-3 (thickness: 130 μm) was obtained in the same manner as Example 2-1, except that the surface temperature T2 of the belt 22 of the touch roll 20 was set to 90° C.

### EXAMPLE 2-4

Thermoplastic resin film F for Example 2-4 was obtained in the same manner as Example 2-1, except that the surface temperature T2 of the belt 22 of the touch roll 20 was set to 100° C.

### EXAMPLE 2-5

Thermoplastic resin film F for Example 2-5 was obtained in the same manner as Example 2-1, except that the surface temperature T2 of the belt 22 of the touch roll 20 was set to 140° C.

### EXAMPLE 2-6

Thermoplastic resin film F for Example 2-6 was obtained in the same manner as Example 2-1, except that the pressing was with a linear pressure 16 N/mm and the surface temperature T2 of the belt 22 of the touch roll 20 was set to 85° C.

### COMPARATIVE EXAMPLE 2-1

Thermoplastic resin film F for Comparative Example 2-1 was obtained in the same manner as Example 2-1, except that the pressing was with a linear pressure 6 N/mm and the surface temperature T2 of the belt 22 of the touch roll 20 was set to 10° C.

### COMPARATIVE EXAMPLE 2-2

For Comparative Example 2-2, the same procedure was followed as in Example 2-1, except that the surface temperature T2 of the belt 22 of the touch roll 20 was set to 170° C.

(Evaluation Results)

During production of each thermoplastic resin film F of Examples 2-1 to 2-6, the thermoplastic resin film F released cleanly from the touch roll 20 and the molding stability was satisfactory. Also, upon visual observation of the thermoplastic resin films F obtained in Example 2, the surface of the thermoplastic resin film F was free of wrinkles and the surface condition was satisfactory. When each of the thermoplastic resin films F of Examples 2-1 to 2-6 was cut to 40 mm×40 mm and the phase difference thereof measured with a KOBRA-WPR by Oji Scientific Instruments Co., Ltd., the phase differences were found to be 8 nm, 1 nm, 10 nm, 15 nm, 20 nm and 17 nm, respectively, which were all sufficiently small values of no greater than 20 nm. Also, when each of the thermoplastic resin films F of Examples 2-1 to 2-6 was cut to 50 mm×50 mm and the haze measured according to JIS K 7136 using a haze meter by Suga Test Instruments Co., Ltd., the values were 5%, 6%, 6%, 6%, 7% and 6%, which were all 7% or lower indicating excellent transparency. Thus, the quality of the thermoplastic resin films F obtained in Examples 2-1 to 2-6 were all evaluated as “G: Good”.

On the other hand, during production of the thermoplastic resin film F of Comparative Example 2-1, the thermoplastic resin film F was poorly releasable from the touch roll 20 and the molding stability was unsatisfactory. Also, upon visual observation of the thermoplastic resin film F obtained in Comparative Example 2-1, the surface of the thermoplastic resin film F was found to contain wrinkles and the surface condition was unsatisfactory. When the thermoplastic resin film F of Comparative Example 2-1 was cut to 40 mm×40 mm and the phase difference thereof measured with a KOBRA-WPR by Oji Scientific Instruments Co., Ltd., the phase difference was found to be 20 nm, which was a sufficiently small value. Also, the haze of the thermoplastic resin film F obtained in Comparative Example 2-1 measured according to JIS K 7136 was 10%, which indicated poor transparency compared to Examples 2-1 to 2-6. Thus, the quality of the thermoplastic resin film F obtained in Comparative Example 2-1 was evaluated as “P: Poor”.

When it was attempted to produce a thermoplastic resin film F in Comparative Example 2-2, the molten resin adhered around the touch roll 20 during molding, making it impossible to obtain a thermoplastic resin film F.

1. A process for producing an optical film made of a thermoplastic resin, comprising:
a melting step of melting and kneading a thermoplastic resin to form a molten resin;
a molding step of discharging the molten resin from a T-shaped die at a temperature of 180° C. or higher and 300° C. or lower, and thereby molding it into a film form; and
a cooling step of cooling and solidifying the molten resin molded in a film form by pressing it a film form with a metal cooling roll and a presser in which one or more rubber rolls are disposed inside a tubular metal belt,
wherein in the cooling step,
the surface temperature of the cooling roll T1 [° C.] is set so as to satisfy the condition represented by the following formula (1), and
the surface temperature of the belt of the presser T2 [° C.] is set so as to satisfy the condition represented by the following formula (2)
Tg−30° C.≦T1≦Tg+50° C. (1)
(Tg [° C.] is the intermediate point glass transition temperature of the thermoplastic resin.)
T1+10° C.≦T2≦T1+150° C. (2).
